(19) United States
(12) Patent Application Publication
(10) Pub. No.: US 2008/0266862 A1
(43) Pub. Date: Oct. 30, 2008

(54) ILLUMINATION OPTICAL APPARATUS

(75) Inventors: Ihar Shyshkin, Suwon-si (KR); Chun-Gi Kim, Suwon-si (KR); Koan-Young Oh, Yongin-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd., Suwon (KR)

(21) Appl. No.: 12/062,446

(22) Filed: Apr. 3, 2008

(30) Foreign Application Priority Data
Apr. 25, 2007 (KR) 10-2007-0040114

(51) Int. Cl. F21V 5/04

(52) U.S. Cl. 362/268

(57) ABSTRACT

Disclosed is an illumination optical apparatus that can enlarge a beam divergence angle. In accordance with an embodiment of the present invention, the illumination optical apparatus can include a light source, emitting a beam of light in a predetermined direction at a beam output point; a ball lens, arranged in a forward direction of the beam of light emitted from the light source; and a condensing lens group, condensing the beam of light which has passed through the ball lens on a predetermined point. With the present invention, the size and the volume of the illumination optical apparatus can be reduced by enlarging the beam divergence angle by further including a ball lens.

### CROSS-REFERENCE TO RELATED PATENT APPLICATIONS

This application claims the benefit of Korean Patent Application No. 10-2007-0040114, filed on Apr. 25, 2007, in the Korean Intellectual Property Office, the disclosure of which is incorporated herein in its entirety by reference.

### BACKGROUND OF THE INVENTION

1. Field of the Invention

The present invention relates to an illumination optical apparatus, more specifically to an illumination optical apparatus that can have a big beam divergence angle of a beam of light emitted from the light source.

2. Background Art

Today's development of display technologies has brought about the increase of demands for small sized display apparatuses such as portable terminals, personal digital assistants (PDA) and portable multimedia players (PMP) as well as big sized display apparatuses such as TV and monitors. Particularly, projection type display apparatuses has been popular with users thanks to their price competitiveness and their appropriateness for realizing big images as compared with other big sized display apparatuses such as CRT TV, LCD TV and PDP TV.

However, since the conventional projection type apparatus has some difficulties in being applied to a small sized display apparatus due to a lot of quantities and complexity of elements (e.g. a light source, a mirror and an optical lens) used to realize an image and necessity to acquire a predetermined spaced distance or projection distance between elements. In other words, the conventional art is limited in miniaturization when realizing the projection type apparatus.

### SUMMARY OF THE INVENTION

Accordingly, the present invention provides an illumination optical apparatus that can reduce the size and volume by including a ball lens.

The present invention also provides an illumination optical apparatus that can be used for a small-sized digital apparatus such as a mobile phone and a PMP as well as a large-sized display apparatus.

An aspect of the present invention features an illumination optical apparatus including an illumination optical apparatus.

According to an embodiment of the present invention, the illumination optical apparatus can include a light source, emitting a beam of light in a predetermined direction at a beam output point; a ball lens, arranged on a path of the beam of light emitted from the light source; and a condensing lens group, condensing the beam of light which has passed through the ball lens on a predetermined point.

Here, the light source can be a laser diode.

Also, the ball lens can have a larger diameter than a beam of light incident on the ball lens at a point in which the ball lens is arranged.

The condensing lens group can include a first lens, having a positive refraction, and receiving the beam of light which has passed through the ball lens and blocking a diffusion of the received beam; a second lens, having a negative refraction, and diffusing the beam of light which has passed through the first lens; a third lens, having the positive refraction, and blocking a diffusion of the beam of light which has passed through the second lens; and a fourth lens, having the positive refraction, and condensing the beam of light which has passed through the third lens on the predetermined point.

### BRIEF DESCRIPTION OF THE DRAWINGS

These and other features, aspects and advantages of the present invention will become better understood with regard to the following description, appended Claims and accompanying drawings where:

FIG. 1 is a plan view showing a lens configuration of a conventional illumination optical apparatus;

FIG. 2 shows the structure of a light source and a ball lens in accordance with an embodiment of the present invention;

FIG. 3 shows the relationship between an incident beam incident on a ball lens and an emitted beam; and

FIG. 4 is a plan view showing the structure of an illumination optical apparatus including a ball lens in accordance with an embodiment of the present invention.

### DESCRIPTION OF THE EMBODIMENTS

Hereinafter, a miniature color display apparatus in accordance with some embodiments of the present invention will be described in detail with reference to the accompanying drawings. Throughout the drawings, similar elements are given similar reference numerals, and corresponding overlapped description will be omitted. Throughout the description of the present invention, when describing a certain technology is determined to evade the point of the present invention, the pertinent detailed description will be omitted.

When one element is described as being “emitted” or “projected” to or on another element, it shall be construed as being emitted to or projected on the other element directly but also as possibly having another element in between. On the other hand, if one element is described as being “directly emitted” to or “directly projected” on another element, it shall be construed that there is no other element in between.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

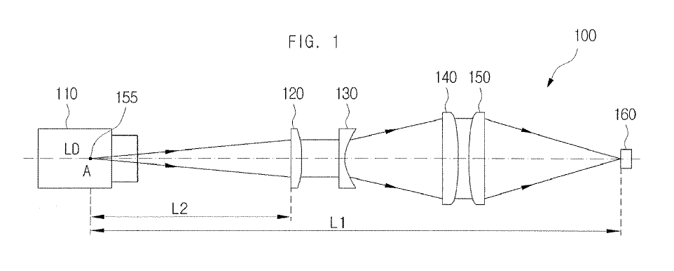

FIG. 1 is a plan view showing a lens configuration of a conventional illumination optical apparatus.

The illumination optical apparatus 100 includes a light source 110, a first lens 120, a second lens 130, a third lens 140 and a fifth lens 150.

The light source 110 can be a laser diode which is placed at a beam output point A 155 to emit a linear beam of light.

The beam of light emitted from the light source 110 passes through the first lens 120 having a positive refraction. Here, a lens having a positive refraction indicates that the divergent level of a beam of light incident on a lens becomes smaller while passing through the lens. A lens having a negative refraction indicates that the divergent level of a beam of light incident on a lens becomes larger while passing through the lens. For example, the lens having the positive refraction (e.g. a convex lens) is used to condense a beam of light, and the lens having the negative refraction (e.g. a concave lens) is used to diffuse a beam of light.

The first leans 120 allows the beam of light diffused from the beam outputted from the beam output point A 155 not to be diffused on a planar surface.

The beam of light, which has passed through the first lens 120, passes through the second lens 130 having the negative refraction. The second lens 130 diffuses the beam of light that has not been diffused after passing through the first lens 120.

The third lens 140 having the positive refraction allows the beam of light, which has passed through the second lens, not to be diffused on a planar surface.

The fourth lens 150 having the positive refraction allows the beam of light, which has passed through the third lens 140, to be condensed on a predetermined point on an optical modulator 160.

The optical modulator 160 modulates the luminance of the beam of light, which is condensed by penetrating the first lens 120 through the fourth lens 150, corresponding to an inputted image signal.

The optical modulator 160 is the optical device that receives a beam (or a color beam) of light emitted from the light source 110 and generates a diffraction beam (i.e. a modulation beam) by modulating the received beam of light according to predetermined light intensity information. Any optical modulator can be applied to the present invention without restriction of its shape and type, for example. Here, the light intensity information refers to image information related to color or black-and-white images actually displayed on a screen.

However, since the optical modulator 160 pertains to well-known optical devices easily understood by any person of ordinary skill in the art, the detailed description related to its structure or optical modulation principle, for example, will be omitted.

The optical modulator 160 modulates a beam of light according to an image signal and outputs a one-dimensional linear image. The one-dimensional linear image can be converted to a two-dimensional image by being projected and scanned on a screen through a projection lens or a scan.

The diffusion of a beam or the blocking of the diffusion is performed on a vertical planar surface with the one-dimensional linear image. For example, the one-dimensional linear image is formed in a vertical direction with the drawing and the diffusion of the beam or the blocking of the diffusion is performed on a planar surface in parallel with the drawing, based on the drawing.

It shall be understood by any person of ordinary skill in the art that the configuration of the first lens 120 through the fourth lens 150 can be realized in various ways in order to allow a beam of light diffused from the light source 110 to be condensed on a predetermined point of the optical modulator 160.

In the illumination optical apparatus 100, the overall length between the beam output point A 155 of the light source 110 and the optical modulator 160 is referred to as L1 and the length for allowing the beam of light emitted from the beam output point A 155 to reach to the first lens 120 is referred to as L2 (refer to FIG. 1).

In other words, the length L2 is required in a minimum in order to allow the beam of light emitted from the beam output point A 155 to be diffused to be suitable for the size of the first lens 120. This is because the divergence angle of the beam of light emitted from the light source 110 is determined.

The prevent invention can reduce the overall size of the illumination optical apparatus 110 by allowing the divergence angle of a beam of light emitted from the light source 110 to become larger, to thereby allow the distance between the light source 110 and the first lens 120 to becomes smaller. Some embodiments of the present invention will be mainly described hereinafter.

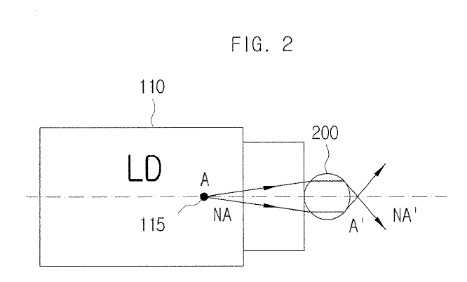

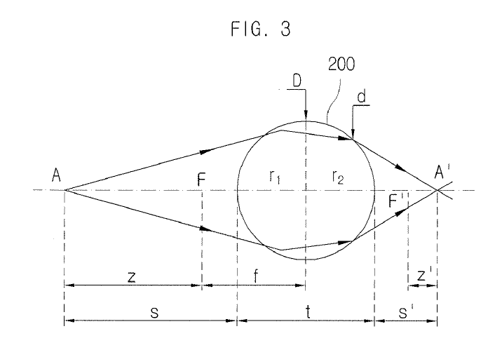

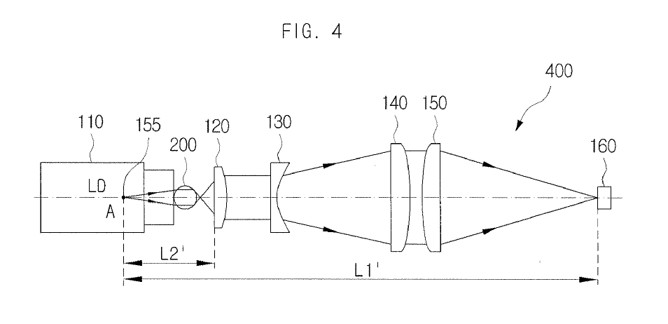

FIG. 2 shows the structure of a light source and a ball lens in accordance with an embodiment of the present invention, and FIG. 3 shows the relationship between an incident beam incident on a ball lens and an emitted beam. FIG. 4 is a plan view showing the structure of an illumination optical apparatus including a ball lens in accordance with an embodiment of the present invention.

The ball lens 200 can have a sphere or ball shape. Conventionally, the ball lens 200 is singly used to collimate the output of an optical fiber or a laser diode or used in a pair for the coupling of fiber to fiber, fiber to laser diode and/or fiber to detector.

In an embodiment of the present invention, the ball lens can be arranged at a point in which a beam of light is emitted from the light source 110 in order to enlarge the divergence angle of a beam of light emitted from the light source 110.

For example, it is assumed that the light source 110 is a green laser diode. The beam of light emitted from the green laser diode can have the diameter of 50˜200□ and the beam divergence angle of 5˜10 mR. In case that the beam divergence angle is 5˜10 mR, the considerable length may be required to allow an output beam of the green laser diode to be diffused to be suitable for the size of the first lens 120. This may make it difficult to miniaturize the illumination optical apparatus.

Accordingly, enlarging the beam divergence angle by using the ball lens makes it possible to miniaturize the illumination optical apparatus by reducing the length between the light source 110 and the first lens 120, which is required to diffuse the output beam to be suitable for the size of the first lens 120.

The effective focal length (EFL) of a lens can be evaluated by the following formula 1.

$$\frac{1}{f} = ( n - 1 ) ( \frac{1}{{r}_{1}} - \frac{1}{{r}_{2}} ) + \frac{{( n - 1 )}^{2}}{n} \frac{t}{{r}_{1} {r}_{2}} \qquad •Formula 1 •$$

Here, f refers to the EFL, and n refers to an index of refraction. r₁ refers to the front curvature radius of a lens and r₂ refers to the back curvature radius of a lens. t refers to the thickness of a lens.

In the case of the ball lens 200, since

$$r = {r}_{1} = - {r}_{2} = \frac{t}{2} = \frac{D}{2} , \qquad$$

the EFL f can be evaluated by the following formula 2.

$$\frac{1}{f} = \frac{2 ( n - 1 )}{nr} \\ f = \frac{nr}{2 ( n - 1 )} = \frac{nD}{4 ( n - 1 )} \qquad •Formula 2 •$$

Here, D refers to the diameter of the ball lens 200. The EFL of the ball lens 200 can be computed by the two variables, which are the diameter D and the refraction coefficient n of the ball lens 200.

The EFL can be measured from the lens center, and the back focal length can be easily evaluated by the following formula 3.

$$EFL = \frac{nD}{4 ( n - 1 )} \\ BFL = f - \frac{D}{2} \qquad •Formula 3 •$$

The numerical aperture NA′ of the ball lens can be dependent on the focal length of the ball lens 200 and the beam output diameter d (refer to the formula 4). The numerical aperture NA′ can show the characteristic related to the angle range of a beam received or emitted by the optical system. Typically, The numerical aperture NA′ can indicate the diameter of a lens aperture in relation to a focal length.

The inherent spherical aberration of the ball lens 200 may be in inverse proportion to d/D. The increase ratio M of the beam divergence angle caused by the ball lens 200 can be represented as the ratio of the distance s between the beam output point A of the light source 110 and the spherical surface of the ball lens 200 to the distance s′ between a beam intersecting point A′ and the spherical surface of the ball lens 200.

$${NA}^{′} = \frac{2 ( n - 1 ) d}{nD} \\ {zz}^{′} = - {f}^{2} \\ M = \frac{{NA}^{′}}{NA} = \frac{s}{{s}^{′}} \qquad •Formula 4 •$$

Here, the NA can refer to the numerical aperture of the beam output point A according to the divergence angle of a beam emitted from the light source 110. The NA′ can refer to the numerical aperture of the beam intersecting point A′ of the beams emitted from the ball lens 200.

For example, the ball lens 200 is assumed to have the refraction coefficient n of 1.859 (using a material such as LaSFN9) and the radius of 0.5 mm. It is also assumed that the distance s between the beam output point A of the light source 110 and the spherical surface of the ball lens 200 is 7 mm and the NA of the beam output point A is 4.75 mR.

In this case, the formulas 1 through 4 can be represented as the following formula 5.

$$f = \frac{1.859 \times 1}{4 \times ( 1.859 - 1 )} = 0.541 mm \\ BFL = 0.541 - 0.5 = 0.041 mm \\ z = s - BFL = 7 - 0.041 = 6.959 mm \\ {z}^{′} = \frac{{f}^{2}}{z} = \frac{{0.541}^{2}}{6.959} = 0.0042 mm \\ {s}^{′} = f + {z}^{′} = 0.541 + 0.042 mm \\ M = \frac{s}{{s}^{′}} = \frac{7}{0.583} = 12 \\ {NA}^{′} = NA \times M = 4.75 mR \times 12 = 57 mR ( {3.26}^{*} ) \qquad •Formula 5 •$$

In other words, the formula 5 shows that allowing the ball lens 200 to be arranged at a point in which a beam of light is emitted from the light source 110 can enlarge the NA in proportion to the beam divergence angle 12 times at a maximum. The increased NA may cause the required distance between the light source 110 and the first lens 120 to become smaller.

Referring to FIG. 4, the distance between the light source 110 (i.e. the beam output point A) of the illumination optical apparatus 400 including the ball lens 200 and the first lens 120 can be referred to as L2′. The distance L2′ can be smaller than L2 of the conventional illumination optical apparatus 100.

The illumination optical apparatus 400 of FIG. 4 can have the same distance between the first lens 120 and the optical modulator 160 as the conventional illumination optical apparatus 100 of FIG. 1.

Accordingly, the illumination optical apparatus 400 in accordance with an embodiment of the present invention can have the overall length L1′ that is smaller than the overall length L1 of the conventional illumination optical apparatus 100.

In the present invention, the ball lens can be placed in various ways according to the size of the ball lens 200. The beam of light incident on the ball lens 200 can have the smaller diameter than the ball lens 200 at the point in which the ball lens 200 is arranged.

As described above, the illumination optical apparatus of the present invention can efficiently enlarge the small beam divergence angle at a beam output point at an inexpensive price by further including a ball lens in order to reduce the overall length of the illumination optical apparatus. This makes it possible to miniaturize the illumination optical apparatus and the display apparatus using the same.

The illumination optical apparatus of the present invention is applicable to small sized display apparatuses such as portable terminals, PDA and PMP.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalents.

What is claimed is:

1. An illumination optical apparatus, comprising:
a light source, emitting a beam of light in a predetermined direction at a beam output point;
a ball lens, arranged on a path of the beam of light emitted from the light source; and
a condensing lens group, condensing the beam of light which has passed through the ball lens on a predetermined point.

2. The apparatus of claim 1, wherein the light source is a laser diode.

3. The apparatus of claim 1, wherein the ball lens has a larger diameter than a beam of light incident on the ball lens at a point in which the ball lens is arranged.

4. The apparatus of claim 1, wherein the condensing lens group comprises:
a first lens, having a positive refraction, and receiving the beam of light which has passed through the ball lens and blocking a diffusion of the received beam;
a second lens, having a negative refraction, and diffusing the beam of light which has passed through the first lens;
a third lens, having the positive refraction, and blocking a diffusion of the beam of light which has passed through the second lens; and
a fourth lens, having the positive refraction, and condensing the beam of light which has passed through the third lens on the predetermined point.

5. The apparatus of claim 4, wherein the optical modulator outputs an one-dimensional linear image corresponding to the beam of light modulated according to an inputted image signal, and
a diffusion of the beam of light or a blocking of the diffusion is performed on a vertical planar surface with the one-dimensional linear image.
